(19) United States
(12) Patent Application Publication
(10) Pub. No.: US 2023/0341179 A1
(43) Pub. Date: Oct. 26, 2023

(54) FREEZE DRY SHELVING WITH INTEGRATED SENSING

(71) Applicant: TechSource Systems LLC, Ogden, UT (US)

(72) Inventors: Matthew Pettit, Mountain Green, UT (US); Allen Pettit, Hurricane, UT (US); Logan Pettit, Layton, UT (US)

(21) Appl. No.: 18/304,329

(22) Filed: Apr. 20, 2023

Related U.S. Application Data
(60) Provisional application No. 63/333,258, filed on Apr. 21, 2022.

(51) Int. Cl. F25D 29/00; F25D 25/02

(52) U.S. Cl. CPC F25D 29/005; F25D 25/02; F25D 2400/02

(57) ABSTRACT

Embodiments of a freeze dry shelf may include a body, a surface layer, and a component, the body may have a planar monolithic form. The surface layer may be applied to a portion of the body. The component may be disposed on a planar geometry of the body to detect a measurement of a condition proximate the body and communicate a signal indicative of the parameter via a contact disposed on an edge of the body.

### CROSS-REFERENCE TO RELATED APPLICATIONS

The present application claims priority to U.S. Provisional Patent Application No. 62/63/333,258 entitled “FREEZE DRY SHELVING WITH INTEGRATED SENSING”, filed on 21 Apr. 2022. The entire contents of the above-listed application are hereby incorporated by reference for all purposes.

### BACKGROUND

Dehydration is an effective form of processing and preservation. Dehydration involves the removal of moisture, generally in the form of water, from a material. Dehydration may be achieved through the application of heat to evaporate water or, alternatively, through the process of sublimation. Freeze drying is a process that relies on sublimation to remove moisture from a material. Freeze drying involves freezing the product and removing solid moisture through sublimation.

### BRIEF DESCRIPTION OF THE DRAWINGS

The present description will be understood more fully when viewed in conjunction with the accompanying drawings of various examples of freeze dry shelving with integrated sensing. The description is not meant to limit the freeze dry shelving with integrated sensing to the specific examples. Rather, the specific examples depicted and described are provided for explanation and understanding of freeze dry shelving with integrated sensing. Throughout the description the drawings may be referred to as drawings, figures, and/or FIGs.

FIG. 1 illustrates a perspective view of a first side of a freeze dry shelf, according to an embodiment.

FIG. 2 illustrates a perspective view of a second side of a freeze dry shelf, according to an embodiment.

FIG. 3 illustrates a perspective view of a rack of freeze dry shelves, according to an embodiment.

### DETAILED DESCRIPTION

Freeze drying shelves with integrated sensing, as disclosed herein, will become better understood through a review of the following detailed description in conjunction with the figures. The detailed description and figures provide merely examples of the various embodiments of freeze dry shelves with integrated sensing. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Some conventional freeze dry shelves are controlled based off of a remotely posited thermocouple. The thermocouple may be positioned in a rack structure, outlet, or other component associated with the shelf or in a system in thermal communication with the rack structure. Systems with remote sensing allow for measurement at a single point or at a location off the shelf. This provides a temperature measurement, but the measurement is not indicative of the temperature across the shelving stack or arrangement.

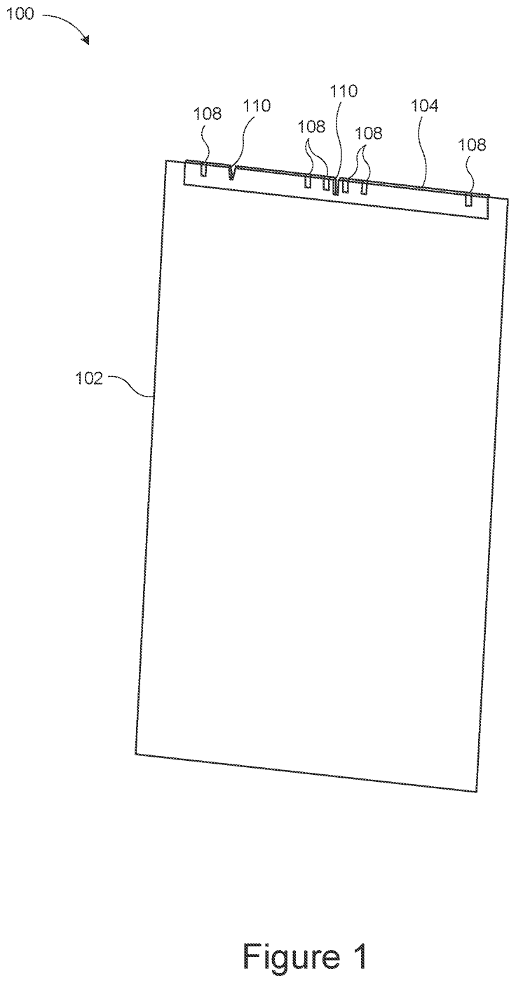

Implementations of freeze dry shelving with integrated sensing may address some or all of the problems described above. Freeze dry shelving with integrated sensing may include temperature or other sensors integrated with the shelving to provide more granular information for monitoring and control of a freeze dry or other unit. FIG. 1 illustrates a perspective view of a first side of a freeze dry shelf 100, according to an embodiment. Embodiments may provide improved granularity for monitoring and control of freeze dry processes.

In some embodiments, the freeze dry shelf 100 includes a body 102. The body 102 may have a relatively planar geometry. For example, the body 102 may be rectangular in geometry with a thin thickness relative to a width and length of the body 102. Embodiments of the freeze dry shelf 100 may have a geometry configured to fit a rack structure or other application specific parameters. In some embodiments, the body 102 may have a monolithic form. For example, the body 102 may be a single sheet of material. Some embodiments of a single sheet may omit any internal layers or duplicate layers. In some embodiments, the body 102 may be a single layer. In other embodiments, the body 102 may be multi-layered. In some embodiments, the body 102 may be formed without folding or overlapping layers.

In some embodiments, the body 102 is composed of a thermally conductive and/or radiative material. In one example, the body 102 includes a metal. In some embodiments, the body 102 may include non-metallic components. In some embodiments, the body 102 may be coated or include other treatments.

In some embodiments, the freeze dry shelf 100 includes surface contacts 108. In some embodiments, the surface contacts 108 provide electrical connection between the freeze dry shelf 100 and another component such as a rack. The surface contacts 108 may facilitate communication of at least one of power supply, a signal for measurement or communication, or so forth. For example, one or more of the surface contacts 108 may provide power or material for heating of the freeze dry shelf 100. For example, the surface contacts 108 may provide electrical power, fluid heat transfer, microwave energy, or the like. In another example, one or more of the surface contacts 108 may facilitate communication of a signal for a measurement such as temperature, humidity, pressure, air flow, or so forth.

In some embodiments, the surface contacts 108 may be positioned on the body 102 to correspond to a particular function or plurality of functions. For example, one or more of the surface contacts 108 may be positioned to correspond to a heating element, a sensor, or so forth. The surface contacts 108 may be coupled to the base 102 to correspond to a location of a surface layer 104.

The surface layer 104 may be disposed on the body 102 to provide functionality relating to wear, electrical conductivity, structural characteristics, thermal conductivity, or so forth. The surface layer 104 may also provide anti-stick properties or other characteristics impacting an interaction with another structure, object, or component. In some embodiments, the surface layer 104 is a coating. In other embodiments, the surface layer 104 is a structure applied to the body 102. For example, the surface layer 104 may be a material sprayed, deposited, or otherwise applied to the body 102 or may be a structure such as a laminate, sheet, or other structure coupled to the body 102 via adhesive or another coupling process or mechanism.

The surface contacts 108 may be coupled to one or both of the base 102 or the surface layer 104 by mechanical force, chemical adhesion, deposition, printing, plating, or so forth. The surface contacts 108 may be removable or integrated. In some embodiments, the surface contacts 108 may be modular to facilitate customization, compatibility, maintenance, or so forth.

In some embodiments, the freeze dry shelf 100 also includes structural notches 110. The structural notches 110 may be formed to extend at least partially through a thickness of the surface layer 104 and/or the base 102. In other embodiments, the structural notches 110 may extend through the surface layer 104 without extending completely through the base 102. The structural notches 110 may have any geometry and profile.

In some embodiments, the structural notches 110 provide physical alignment for the freeze dry shelf 100 with another structure such as a coupler, mount, rack, or so forth. For example, a structural notch 110 may be positioned or shaped to guide orientation of the freeze dry shelf 100 to reduce the chance of positioning the freeze dry shelf 100 upside down. In another example, a structural notch 110 may be positioned to guide lateral alignment. This may reduce damage to the freeze dry shelf 100, facilitate connection of the surface contacts 108, or so forth.

The structural notches 110 may also include electrical connections or other components to offer additional functionality. For example, at least one of the structural notches 110 may include an electrical connection. In another example, a sensor may be integrated with a structural notch 110.

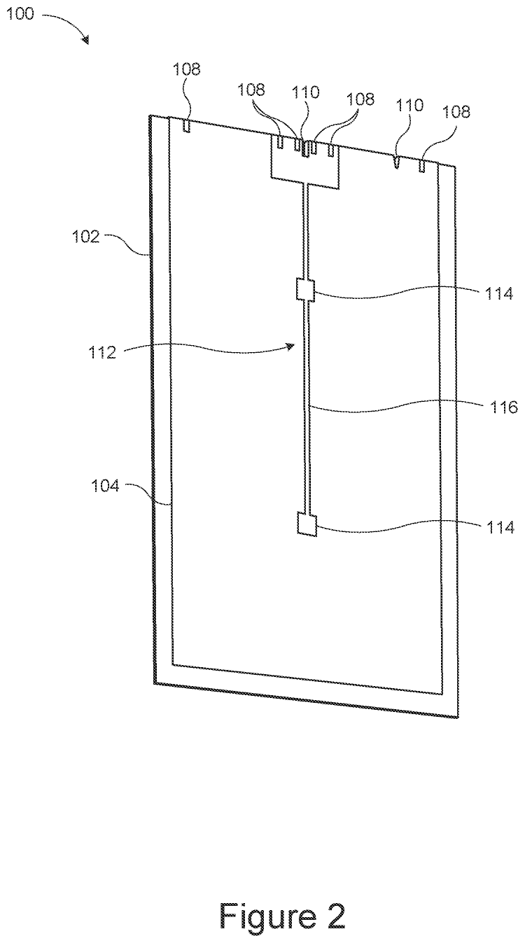

FIG. 2 illustrates a perspective view of a second side of a freeze dry shelf 100, according to an embodiment. Embodiments may allow for more effective and efficient freeze drying.

In some embodiments, the freeze dry shelf 100 includes a component array 112. The component array 112 may correspond with one or more of the surface contacts 108 and/or one or more of the structural notches 110. In some embodiments, the component array 112 is disposed on one side of the freeze dry shelf 100. In other embodiments, the component array 112 may be disposed on both sides of the freeze dry shelf 100.

In some embodiments, the component array 112 extends from one or more surface contacts 108 and or structural notches 110 across a geometry of the freeze dry shelf 100. For example, the component array 112 may extend from an edge of the freeze dry shelf 100 inward. Other paths and patterns may be used. In some embodiments, at least a portion of the component array 112 is positioned beneath the surface layer 104. In other embodiments, at least a portion of the component array 112 may be position on top of the surface layer 104.

The component array 112 may include one or more components 114 and one or more leads 116. In some embodiments, the components 114 may include a sensor. For example, the component 114 may be a thermal sensor. One example of a thermal sensor is an integrated circuit temperature device (ICTB). Other examples may include thermocouples, thermistors, or so forth. Some embodiments of the component array 112 may include multiple sensor types. For example, the components 114 may include one or more types of thermal sensors and/or one or more types of pressure sensors. Other numbers of sensors and/or sensor combinations may be implemented.

In some embodiments, the components 114 of the component array 112 are connected via a coupling 116. The coupling 116 may be a conductor extending between the components 114 in a straight line or along a non-linear path. The coupling 116 may also connect one or more of the components 114 to the surface contacts 108. In some embodiments, each component 114 may have a corresponding coupling 116 connecting the component 114 to one or more of the surface contacts 108.

In some embodiments, the components 114 and/or couplings 116 may be secured relative to the body 102 by the surface layer 104. In other embodiments, the components 114 and/or couplings 116 may be secured relative to the body 102 on the surface layer 104 by a corresponding material or layer applied over the components 114 and/or couplings 116 on the surface layer 104. In some embodiments, the components 114 and/or the couplings 116 may be removable/swappable. In other embodiments, the components 114 and/or the couplings 116 may be non-removable.

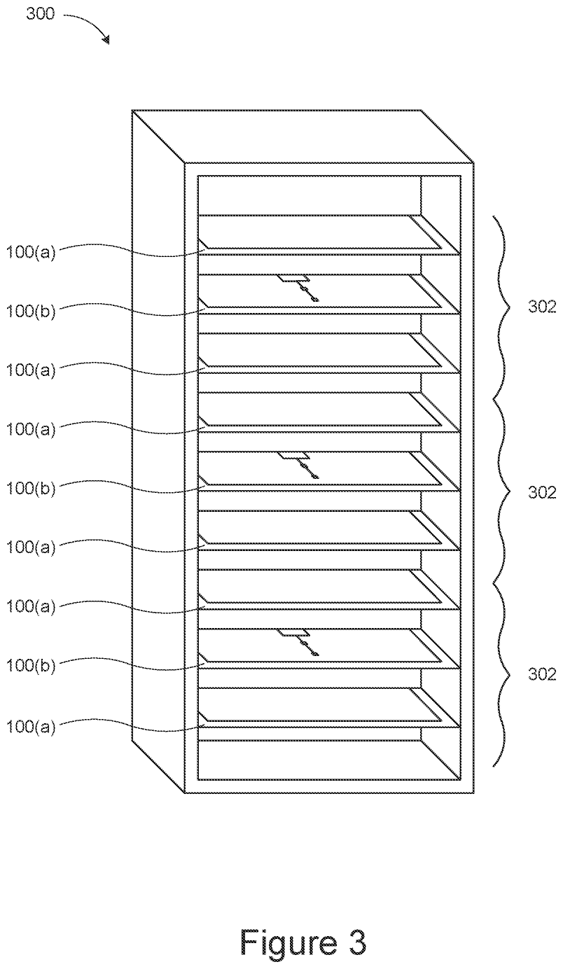

FIG. 3 illustrates a perspective view of a rack 300 of freeze dry shelves 100, according to an embodiment. Embodiments may allow for multizone sensing for improved monitoring and control.

Embodiments of the rack 300 may include a plurality of freeze dry shelves 100. In some embodiments, the rack 300 may include active one or more non-sensing shelves 100(a) and one or more sensing shelves 100(b). In some embodiments, the sensing shelves 100(b) may be distributed in the rack 300 to sense corresponding sensing zones 302. In some embodiments, the sensing shelves 100(b) may be positioned in a zone 302 with one or more non-sensing shelves 100(a). The sensing shelves 100(b) may be configured to detect a temperature or other parameter. The detection may be attributed to the corresponding zone and adjustments may be made to the corresponding zone providing a more accurate and efficient control scheme for the rack 300, as a whole.

In some embodiments, the rack 300 may include electrical connections to facilitate positioning of the sensing shelves 100(b) in particular locations within the rack 300. In other embodiments, the rack 300 may include electrical connections to facilitate placement of the sensing shelves 100(b) at any location within the rack 300. The rack 300 may be configured to determine locations for sensing shelves 100(b) within the rack 300. In some embodiments, the rack 300 is configured to communicate a reading from a sensing shelf 100(b) with a corresponding location and/or zone 302. The reading may be attributed or otherwise calculated with other shelves 100 in the same zone 302.

In some embodiments, multiple zones 302 may be compared to determine a thermal management scheme. In some embodiments, the zones 302 may be compared and a calculated thermal scheme implemented to address parameters in a corresponding zone 302. In some embodiments, the rack 300 includes fixed mounting points for the shelves 100. In other embodiments, the shelves 100 may be secured and connected at variable mounting locations.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. An apparatus, comprising:
a freeze dry shelf having a body comprising a planar rectangular geometry;
a surface layer applied to a portion of the body; and
a component disposed on the body of the freeze dry shelf to:
detect a measurement of a condition proximate the body;
communicate a signal indicative of the parameter via a contact disposed on an edge of the body.

2. The apparatus of claim 1, wherein the component forms a portion of a component array disposed on the body.

3. The apparatus of claim 2, wherein the component array further comprises a coupling extending between the component and at least one of another component or the contact.

4. The apparatus of claim 2, wherein the component array comprises at least one heater and at least one sensor.

5. The apparatus of claim 2, wherein the component array is distributed with the component disposed at a distance from the contact.

6. The apparatus of claim 1, wherein the component comprises at least one of a sensor and a heating element.

7. The apparatus of claim 1, wherein the component is disposed along a middle of the body.

8. A system, comprising:
a freeze dry shelf having a body forming a sheet;
a surface layer applied to a portion of the body;
at least one contact disposed on an edge of the body;
a first component coupled to the at least one contact and configured to detect a measurement of a condition proximate the body; and
a second component coupled to the at least one contact and configured to apply heat to the body.

9. The system of claim 8, wherein the first component and the second component form a component array.

10. The system of claim 9, wherein the component array further comprises a coupling in electrical communication with at least one of the first component and the second component.

11. The system of claim 9, wherein the component array is distributed with one or more of the first component and the second component disposed at a distance from the at least one contact.

12. The system of claim 9, wherein the component array comprises at least one of a plurality of sensors or a plurality of heating elements.

13. The system of claim 8, wherein the first component corresponds to a first contact of the at least one contact and the second component corresponds to a second contact of the at least one contact.

14. The system of claim 8, wherein at least one of the first component or the second component is disposed along a middle of the body.

15. A method, comprising:
forming a freeze dry shelf having a body comprising a planar rectangular geometry;
applying a surface layer to a portion of the body;
disposing at least one contact on an edge of the body;
coupling a first component to the at least one contact to detect a measurement of a condition proximate the body; and
coupling a second component to the at least one contact to apply heat to the body.

16. The method of claim 15, wherein the first component and the second component form a component array.

17. The method of claim 16, further comprising disposing a coupling in electrical communication with at least one of the first component and the second component.

18. The method of claim 16, wherein the component array is distributed with one or more of the first component and the second component disposed at a distance from the at least one contact.

19. The method of claim 16, wherein the component array comprises at least one of a plurality of sensors or a plurality of heating elements.

20. The method of claim 15, wherein the first component corresponds to a first contact of the at least one contact and the second component corresponds to a second contact of the at least one contact.
